(19) United States
(12) Patent Application Publication
(10) Pub. No.: US 2023/0412243 A1
(43) Pub. Date: Dec. 21, 2023

(54) RECEPTION APPARATUS, AND RECEPTION METHOD

(71) Applicant: NIPPON TELEGRAPH AND TELEPHONE CORPORATION, Tokyo (JP)

(72) Inventors: Doohwan LEE, Tokyo (JP); Hirofumi SASAKI, Tokyo (JP); Yasunori YAGI, Tokyo (JP); Takayuki YAMADA, Tokyo (JP); Tomoki SEMOTO, Tokyo (JP); Jun MASHINO, Tokyo (JP)

(21) Appl. No.: 18/252,080

(22) PCT Filed: Nov. 17, 2020
(86) PCT No.: PCT/JP2020/042781

§ 371 Date: May 8, 2023

(51) Int. Cl. H04B 7/08; H01Q 3/32; H04B 7/0404

(52) U.S. Cl. CPC H04B 7/084; H01Q 3/32; H04B 7/0404

(57) ABSTRACT

A reception device includes a first antenna, a second antenna, and a control unit that combines signals of a radio wave in a first orbital angular momentum (OAM) mode and a radio wave in a second OAM mode having a sign only that is different from a sign of the first OAM mode, received by the first antenna, with signals obtained by rotating OAM phases of the radio wave in the first OAM mode and the radio wave in the second OAM mode received by the second antenna by a predetermined angle to extract a signal of the radio wave in the first OAM mode, and combines signals of the radio wave in the first OAM mode and the radio wave in the second OAM mode received by the second antenna with signals obtained by rotating OAM phases of the radio wave in the first OAM mode and the radio wave in the second OAM mode received by the first antenna by the predetermined angle to extract a signal of the radio wave in the second OAM mode.

### TECHNICAL FIELD

The present disclosure relates to a reception device and a reception method.

### BACKGROUND ART

In recent years, a technique for improving a transmission capacity by spatially multiplexing and transmitting a radio signal by using orbital angular momentum (OAM) of a radio wave has been studied.

In a radio wave having OAM, an equiphase surface is spirally distributed in a propagation direction around a propagation axis. Since spatial phase distributions of respective electromagnetic waves propagating in the same direction with different phase rotation numbers (OAM modes) are orthogonal in a rotation axis direction, it is possible to multiplex and transmit signals by separating the signals in the OAM modes modulated with different signal sequences on a reception side. There is a technique of performing spatial multiplex transmission of different signal sequences by transmitting respective radio waves in a plurality of OAM modes generated by using a uniform circular array (UCA) in which a plurality of antenna elements are circularly arranged at equal intervals (refer to, for example, Patent Literature 1.).

### CITATION LIST

### Patent Literature

Patent Literature 1: JP 2019-062296 A

### SUMMARY OF INVENTION

### Technical Problem

However, in the related art, there is a problem that a processing load of separating the signals in the respective OAM modes on a reception side increases.

In one aspect, an object of the present invention is to provide a technique capable of reducing a processing load of separating signals in respective OAM modes.

### Solution to Problem

According to an aspect, there is provided a reception device including a first antenna; a second antenna; and a control unit that combines signals of a radio wave in a first orbital angular momentum (OAM) mode and a radio wave in a second OAM mode having a sign only that different from a sign of the first OAM mode, received by the first antenna, with signals obtained by rotating OAM phases of the radio wave in the first OAM mode and the radio wave in the second OAM mode received by the second antenna by a predetermined angle to extract a signal of the radio wave in the first OAM mode, and combines signals of the radio wave in the first OAM mode and the radio wave in the second OAM mode received by the second antenna with signals obtained by rotating OAM phases of the radio wave in the first OAM mode and the radio wave in the second OAM mode received by the first antenna by the predetermined angle to extract a signal of the radio wave in the second OAM mode.

### Advantageous Effects of Invention

According to one aspect, it is possible to reduce a processing load of separating signals in respective OAM modes.

### BRIEF DESCRIPTION OF DRAWINGS

FIG. 1 is a diagram for describing a configuration of a communication system according to an embodiment.

FIG. 2 is a diagram for describing configurations of a terminal and a base station according to the embodiment.

FIG. 3 is a diagram for describing an arrangement example of respective antennas of the terminal according to the embodiment.

FIG. 4 is a sequence diagram for describing an example of a process of transmitting data from the base station to the terminal according to the embodiment.

FIG. 5 is a flowchart for describing an example of a reception process in the terminal according to the embodiment.

FIG. 6A is a diagram for describing an example of a process of receiving a radio wave in an OAM mode received by each antenna of the terminal according to the embodiment.

FIG. 6B is a diagram for describing an example of a process of receiving a radio wave in an OAM mode received by each antenna of the terminal according to the embodiment.

FIG. 6C is a diagram for describing an example of a process of receiving a radio wave in an OAM mode received by each antenna of the terminal according to the embodiment.

FIG. 6D is a diagram for describing an example of a process of receiving a radio wave in an OAM mode received by each antenna of the terminal according to the embodiment.

### DESCRIPTION OF EMBODIMENTS

Hereinafter, an embodiment of the present invention will be described with reference to the drawings.

<Overall Configuration>

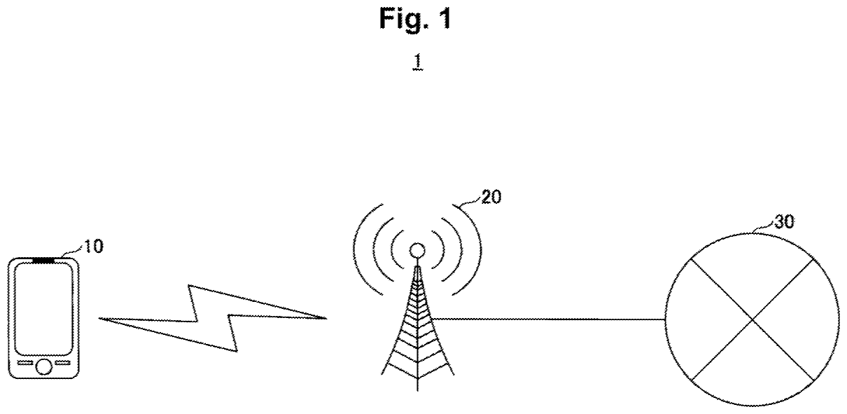

FIG. 1 is a diagram for describing a configuration of a communication system 1 according to an embodiment. In the example in FIG. 1, the communication system 1 includes a terminal 10 and a base station 20. The numbers of the terminals 10 and the base stations 20 are not limited to the example in FIG. 1. The terminal 10 is an example of a reception device. The base station 20 is an example of a transmission device.

The terminal 10 and the base station 20 perform wireless communication conforming to a standard such as 6th Generation Mobile Communication System (6G), 5G, 4G, long term evolution (LTE), 3G, or a wireless local area network (LAN).

The terminal 10 may be, for example, an information processing terminal such as a smartphone, a tablet terminal, or a notebook personal computer (PC). The terminal 10 may be, for example, a moving object such as a vehicle that travels on land by wheels, a robot that moves by a leg or the like, an aircraft, or an unmanned aerial vehicle (drone). Examples of the vehicle include an automobile, a motorcycle (motor bike), a robot that moves by wheels, and a railway vehicle that travels on a railway. Examples of the automobile include an automobile traveling on a road, a tram, a construction vehicle used for construction, a military vehicle for military use, an industrial vehicle for cargo handling, and an agricultural vehicle.

The terminal 10 may be, for example, a communication device having a wireless communication function such as a machine-to-machine (M2M) communication module.

The base station 20 is a radio station that communicates with the terminal 10. The base station 20 transmits data to the terminal 10 by using radio waves having orbital angular momentum (OAM). The base station 20 receives data from the terminal 10 according to wireless communication using any known method.

The base station 20 may be fixedly installed on, for example, the ground (land). The base station 20 may be mounted on, for example, a high altitude platform station or high altitude pseudo satellite (HAPS) for non-terrestrial networks (NTN), a flying object such as an unmanned aerial vehicle, or a spacecraft such as a satellite.

The base station 20 is connected to the network 30 via a wired cable or the like. The terminal 10 communicates with an external server or the like on the Internet or the like via the base station 20 and the network 30.

<Configuration>

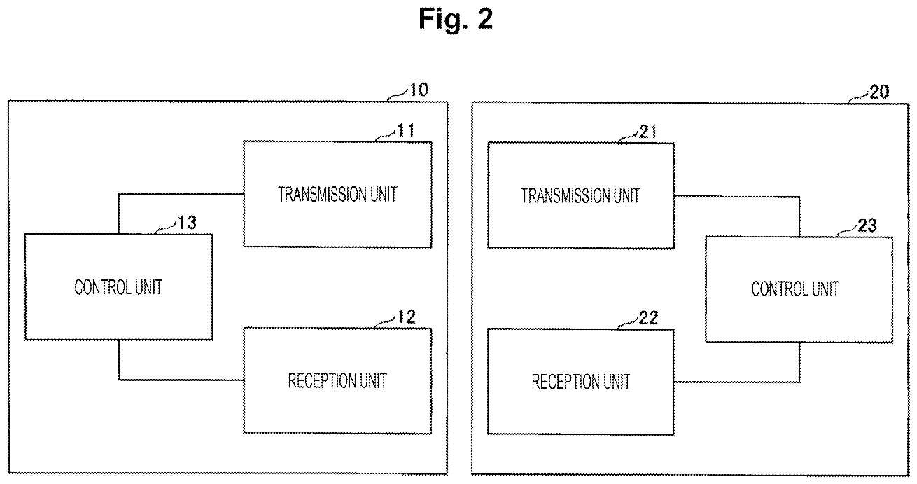

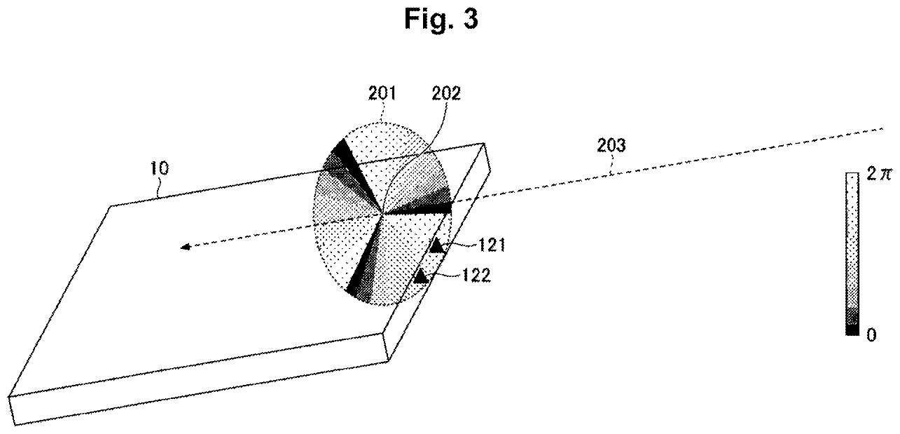

Next, configurations of the terminal 10 and the base station 20 according to the embodiment will be described with reference to FIGS. 2 and 3. FIG. 2 is a diagram for describing configurations of the terminal 10 and the base station 20 according to the embodiment. FIG. 3 is a diagram for describing an arrangement example of respective antennas of the terminal 10 according to the embodiment.

<<Base Station 20>>

In the example in FIG. 2, the base station 20 includes a transmission unit 21, a reception unit 22, and a control unit 23. The transmission unit 21 transmits data to the terminal 10 by transmitting a radio wave having OAM. For example, the transmission unit 21 may transmit respective radio waves with a plurality of phase rotation numbers (for example, seven including −3, −2, −1, 0, 1, 2, and 3) generated by using a uniform circular array (UCA) in which a plurality of antenna elements are circularly arranged at equal intervals. Hereinafter, the phase rotation number of the radio wave having the OAM will be referred to as an OAM mode.

The reception unit 22 receives data from the terminal 10 through wireless communication. The control unit 23 controls each unit of the base station 20.

<<Terminal 10>>

In the example in FIG. 2, the terminal 10 includes a transmission unit 11, a reception unit 12, and a control unit 13. The transmission unit 11 transmits data to the base station 20 through wireless communication.

The reception unit 12 receives a radio wave having QAM from the base station 20. The control unit 13 controls each unit of the terminal 10. The control unit 13 acquires data transmitted from the base station 20, for example, by processing a signal of a radio wave having OAM received by the reception unit 12.

In the example in FIG. 3, the reception unit 12 of the terminal 10 includes an antenna 121 and an antenna 122. The antenna 121 and the antenna 122 are provided at locations separated by a predetermined distance (for example, 1 cm).

<Processing>

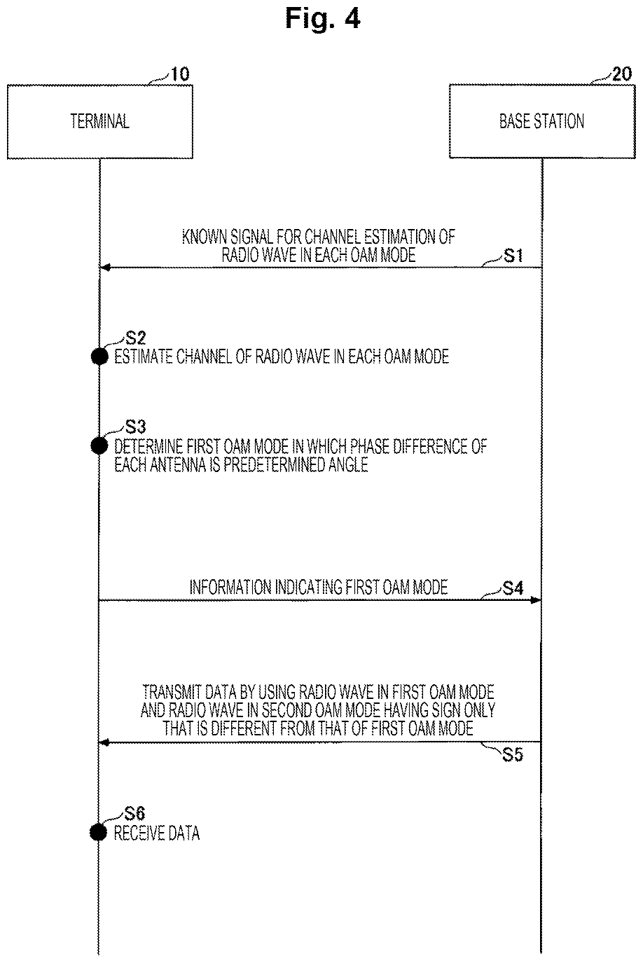

Next, an example of a process of transmitting data (downlink) from the base station 20 to the terminal 10 in the communication system 1 according to the embodiment will be described with reference to FIGS. 3 and 4. FIG. 4 is a sequence diagram for describing an example of a process of transmitting data from the base station 20 to the terminal 10 in the communication system 1 according to the embodiment.

In step S1, the transmission unit 21 of the base station 20 transmits, to the terminal 10, a known signal or the like for channel estimation of a radio wave in each OAM mode that can be transmitted from the transmission unit 21 to the terminal 10.

The base station 20 may perform the process in step S1, for example, in a case of receiving a predetermined request from the terminal 10 in a downlink control channel.

Subsequently, the terminal 10 performs channel estimation on the basis of the known signal for channel estimation received from the base station 20 (step S2). Here, for example, the terminal 10 may perform channel estimation for a channel in each OAM mode by using a well-known method such as zero forcing (ZF) or minimum mean square error (MMSE).

Subsequently, the control unit 13 of the terminal 10 determines a radio wave in a first OAM mode in which a difference (phase difference) between an OAM phase of the radio wave received by the antenna 121 and an OAM phase of the radio wave received by the antenna 122 falls within a predetermined range including a predetermined angle among the radio waves in the respective OAM modes received from the base station 20 (step S3). Here, the predetermined angle may be, for example, 90 degrees. The predetermined range may be, for example, 80 degrees to 100 degrees. The predetermined range may be set in the terminal 10 in advance according to, for example, the processing capability of the terminal 10.

The technique of the present disclosure is more suitable as the predetermined angle becomes closer to 90 degrees, and as a deviation degree increases, the interference between OAM modes having different signs increases, and a signal to interference and noise ratio or a signal-to-Interference-plus-noise ratio (SINR) decreases. In a case where the phase difference is not the predetermined angle, the control unit 13 of the terminal 10 may reduce at least one of a spatial multiplexing number and a modulation multi-level number of the radio signal transmitted from the base station 20 to the terminal 10. Consequently, for example, a signal processing load in the terminal 10 can be reduced. The SINR can be improved.

In this case, the terminal 10 may transmit information indicating the phase difference to the base station 20, and the base station 20 may determine at least one of the spatial multiplexing number and the modulation multi-level number on the basis of the information indicating the phase difference received from the terminal 10. In this case, the base station may decrease at least one of the spatial multiplexing number and the modulation multi-level number as the degree of deviation (deviation degree) of the phase difference from the predetermined angle increases. In this case, for example, in a case where the deviation degree is equal to or more than a threshold value, the terminal 10 and the base station 20 may use 16 quadrature amplitude modulation (QAM) or the like instead of 64 QAM.

In the example in FIG. 3, the phase of the radio wave transmitted from the base station 20 and having the OAM mode of 3 is indicated by a circle 201. A center position 202 of the circle 201 is a position on a center axis (propagation axis) 203 of the radio wave in the OAM mode transmitted from the base station 20.

In the example in FIG. 3, the position of the antenna 121 and the position of the antenna 122 are separated by 30 degrees as viewed from the center position 202. Therefore, for the radio wave of which the OAM mode is 3, since the phase rotation number is 3, a difference between the phase at the position of the antenna 121 and the phase at the position of the antenna 122 is 90 degrees (=30 degrees×3).

In a case where there is no QAM mode in which the phase difference is within the predetermined range including the predetermined angle, the terminal 10 may transmit, to the base station 20, information designating one OAM mode among the radio waves in the respective OAM mode received from the base station 20. The base station 20 may transmit data to the terminal 10 by using a radio wave in the designated one OAM mode.

For example, the terminal 10 may determine whether or not the phase difference is within the predetermined range including the predetermined angle for a radio wave in only each OAM mode (for example, 1, 2, or 3) which is a positive integer among the OAM modes.

Subsequently, the transmission unit 11 of the terminal 10 transmits information indicating the first OAM mode to the base station 20 (step S4).

Subsequently, the transmission unit 21 of the base station 20 transmits data to the terminal 10 by using a radio wave in the first OAM mode and a radio wave in a second OAM mode having a sign only that is different from that of the first OAM mode (step S5). Here, for example, in a case where the first OAM mode is 1, the second OAM mode is −1; in a case where the first OAM mode is 2, the second OAM mode is −2; and in a case where the first OAM mode is 3, the second OAM mode is −3.

Subsequently, the control unit 13 of the terminal 10 acquires the data transmitted from the base station 20 on the basis of the radio wave in the first OAM mode and the radio wave in the second OAM mode (step S6).

<<Reception Process in Terminal 10>>

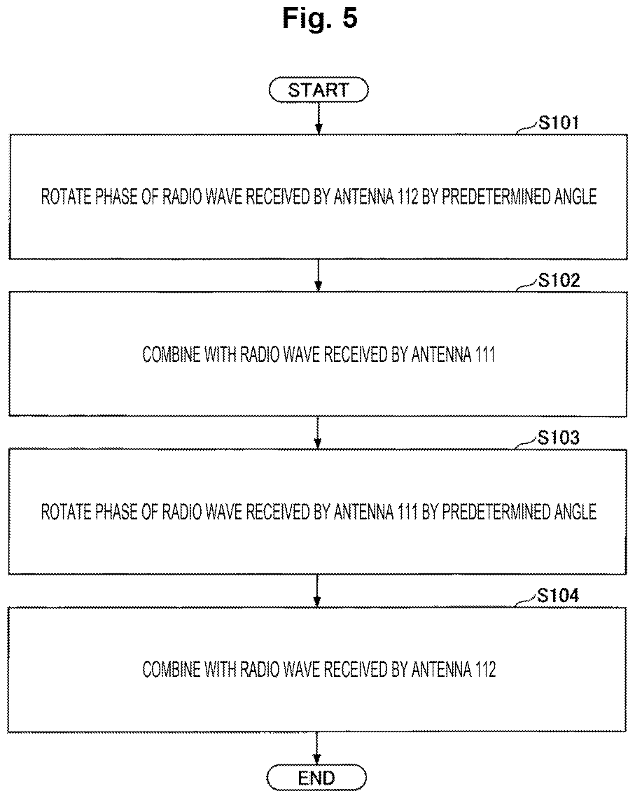

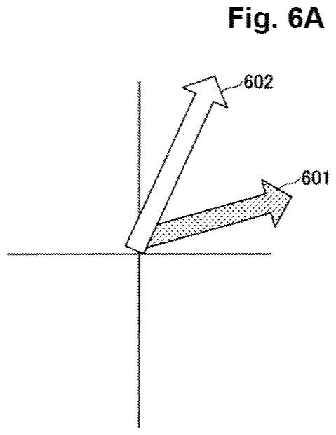

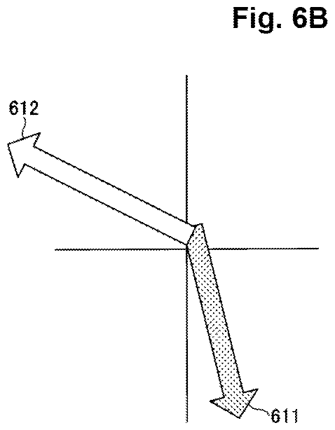

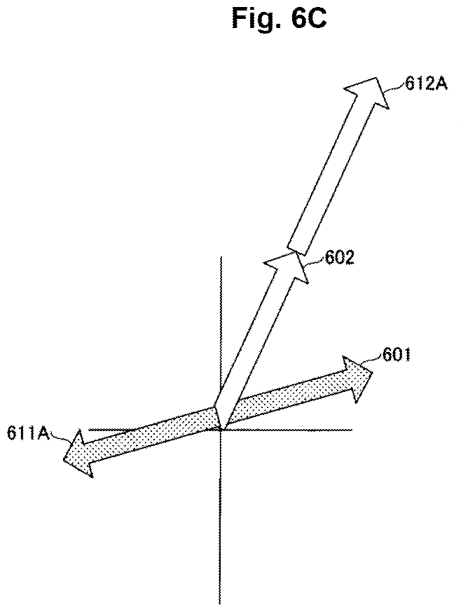

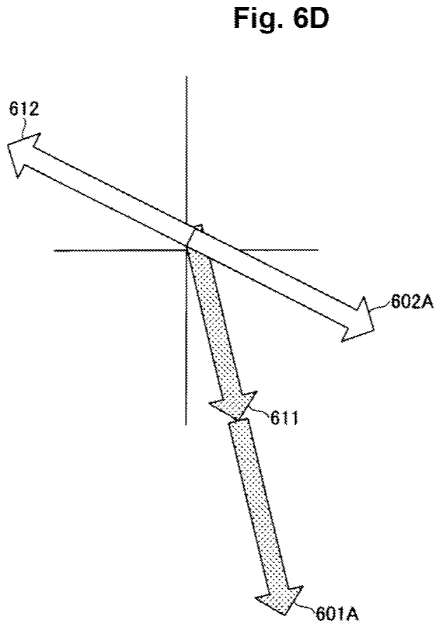

Next, an example of a reception process in step S6 in FIG. 4 in the terminal 10 according to the embodiment will be described with reference to FIGS. 5 to 6D. FIG. 5 is a flowchart for describing an example of a reception process in the terminal 10 according to the embodiment. FIGS. 6A to 6D are diagrams for describing an example of a process of receiving a radio wave in an OAM mode received by each antenna of the terminal 10 according to the embodiment.

In step S101, the control unit 13 of the terminal 10 generates a signal in which an OAM phase of the radio wave is rotated by a predetermined angle on the basis of the radio wave received by the antenna 122.

Subsequently, the control unit 13 of the terminal 10 combines (adds) the signal of the radio wave received by the antenna 121 with the signal generated in step S101 to extract the signal in the second OAM mode (step S102).

FIG. 6A illustrates an example of a radio wave 601 in the first OAM mode received by the antenna 121 and a radio wave 602 in the second OAM mode received by the antenna 121 in a case where the predetermined angle is 90 degrees. FIG. 6B illustrates an example of a radio wave 611 in the first OAM mode received by the antenna 122 and a radio wave 612 in the second OAM mode received by the antenna 122 in a case where the predetermined angle is 90 degrees.

In the examples in FIGS. 6A and 6B, since the predetermined angle is 90 degrees, a phase difference between a phase of the radio wave 601 in the first OAM mode received by the antenna 121 and a phase of the radio wave 611 in the first OAM mode received by the antenna 122 is 90 degrees as described in the process in step S3 of FIG. 4.

As described above, the second OAM mode is different from the first OAM mode in terms of only sign. Thus, the radio wave in the second OAM mode has the same phase rotation amount as that of the radio wave in the first OAM mode, and a rotation direction is reversed. Thus, a phase difference between a phase of the radio wave 602 in the second OAM mode received by the antenna 121 and a phase of the radio wave 612 in the second OAM mode received by the antenna 122 is −90 degrees, which is different from the predetermined angle described above only in the sign.

Through the process in step S102, as illustrated in FIG. 6C, signals obtained by rotating the signals in the first OAM mode and the second OAM mode received by the antenna 122 by 90 degrees are added to the signals in the first OAM mode and the second OAM mode received by the antenna 121. In the example in FIG. 6C, a radio wave 611A is obtained by rotating the radio wave 611 in the first OAM mode received by the antenna 122 illustrated in FIG. 6B clockwise by 90 degrees. A radio wave 612A is obtained by rotating the radio wave 612 in the second OAM mode received by the antenna 122 illustrated in FIG. 6B clockwise by 90 degrees. As a result, the radio wave 611A in the first OAM mode and the radio wave 601 cancel out each other, and a signal in which the radio wave 602 in the second OAM mode has a double amplitude can be extracted.

Subsequently, the control unit 13 of the terminal 10 generates a signal obtained by rotating the phase of the radio wave by the predetermined angle on the basis of the radio wave received by the antenna 121 (step S103).

Subsequently, the control unit 13 of the terminal 10 combines (adds) the signal of the radio wave received by the antenna 122 and the signal generated in step S103 to extract the signal of the first OAM mode (step S104).

By the processing in step S104, as illustrated in FIG. 6D, signals obtained by rotating the signals in the first OAM mode and the second OAM mode received by the antenna 121 by 90 degrees are added to the signals in the first OAM mode and the second OAM mode received by the antenna 122. In the example in FIG. 6D, the radio wave 601A is obtained by rotating the radio wave 601 in the first OAM mode received by the antenna 121 illustrated in FIG. 6A clockwise by 90 degrees. The radio wave 602A is obtained by rotating the radio wave 602 in the second OAM mode received by the antenna 121 illustrated in FIG. 6A clockwise by 90 degrees. Consequently, the radio wave 602A in the second OAM mode and the radio wave 612 cancel out each other, and a signal in which the radio wave 611 in the first OAM mode has a double amplitude can be extracted.

The processes from step S101 to step S104 in FIG. 5 by the control unit 13 of the terminal 10 may be executed by a digital circuit or an analog circuit.

### Modification Examples

In the above-described example, an example in which the terminal 10 uses two predetermined antennas has been described. Alternatively, the terminal 10 may determine two antennas to be used for reception from among three or more antennas. Consequently, in step S3 in FIG. 4, it is possible to reduce the absence of the OAM mode in which the phase difference of the OAM of the radio waves received by the two antennas is within the predetermined range including the predetermined angle.

In this case, in step S3 in FIG. 4, the control unit 13 of the terminal 10 may determine a first antenna and a second antenna in which a phase difference between the OAM phase of the radio wave received by the first antenna and the OAM phase of the radio wave received by the second antenna is within the predetermined range including the predetermined angle among the three or more antennas. The terminal 10 may set the antenna 121 of the embodiment of the present disclosure described above as the first antenna and the antenna 122 as the second antenna, and perform the processes in and after step S3 in FIG. 4.

In the above-described example, an example in which each antenna of the terminal 10 is fixed to the terminal 10 has been described. Alternatively, the terminal 10 may be configured such that at least one position of the respective antennas can be moved by an actuator. Consequently, in step S3 in FIG. 4, it is possible to reduce the absence of the OAM mode in which the phase difference of the OAM of the radio waves received by the two antennas is within the predetermined range including the predetermined angle.

In this case, for example, the control unit 13 of the terminal 10 may control the actuator to move the position of the antenna 122 such that a phase difference between the OAM phase of the radio wave received by the antenna 121 and the OAM phase of the radio wave received by the antenna 122 falls within the predetermined range including the predetermined angle.

### Effects of Present Disclosure

In the related art, there is a problem that a processing load of separating signals in respective OAM modes on a reception side increases. For example, in a case where interference occurs between radio waves in respective OAM modes, a processing load of separating signals in the respective OAM modes increases. This processing load increases as a bandwidth increases.

According to the present disclosure, it is possible to reduce a processing load of separating signals in respective OAM modes. Consequently, for example, communication such as downlink can be widened in bandwidth. An antenna can be downsized compared with a configuration in which a UAC is provided on a reception side.

Although the embodiment of the present invention has been described in detail above, the present invention is not limited to such specific embodiment, and various modifications and changes can be made within the scope of the spirit of the present invention described in the claims.

### REFERENCE SIGNS LIST

1 Communication system
10 Terminal
11 Transmission unit
12 Reception unit
121 Antenna
122 Antenna
13 Control unit
20 Base station
21 Transmission unit
22 Reception unit
23 Control unit
30 Network

1. A reception device comprising:
a first antenna;
a second antenna;
a memory; and
a processor coupled to the memory and configured to
combine signals of a radio wave in a first orbital angular momentum (OAM) mode and a radio wave in a second OAM mode having a sign only that is different from a sign of the first OAM mode, received by the first antenna, with signals obtained by rotating OAM phases of the radio wave in the first OAM mode and the radio wave in the second OAM mode received by the second antenna by a predetermined angle to extract a signal of the radio wave in the first OAM mode, and
combine signals of the radio wave in the first OAM mode and the radio wave in the second OAM mode received by the second antenna with signals obtained by rotating OAM phases of the radio wave in the first OAM mode and the radio wave in the second OAM mode received by the first antenna by the predetermined angle to extract a signal of the radio wave in the second OAM mode.

2. The reception device according to claim 1, wherein the predetermined angle is 90 degrees.

3. The reception device according to claim 1, wherein the processor is further configured to
transmit, to a transmission device, information indicating an OAM mode in which a phase difference between an OAM phase of a radio wave received by the first antenna and an OAM phase of a radio wave received by the second antenna among radio waves in a plurality of OAM modes transmitted from the transmission device falls within a predetermined range including the predetermined angle.

4. The reception device according to claim 1, wherein the reception device has three or more antennas, and
the processor is configured to determine, among the three or more antennas, the first antenna and the second antenna in which a phase difference between an OAM phase of a radio wave received by the first antenna and an OAM phase of a radio wave received by the second antenna falls within a predetermined range including the predetermined angle.

5. The reception device according to claim 1, further comprising:
an actuator that moves a position of the second antenna such that a phase difference between an OAM phase of a radio wave received by the first antenna and an OAM phase of a radio wave received by the second antenna falls within a predetermined range including the predetermined angle.

6. A reception method executed by a reception device including a first antenna and a second antenna, the reception method comprising:
combining signals of a radio wave in a first orbital angular momentum (OAM) mode and a radio wave in a second OAM mode having a sign only that is different from a sign of the first OAM mode, received by the first antenna, with signals obtained by rotating OAM phases of the radio wave in the first OAM mode and the radio wave in the second OAM mode received by the second antenna by a predetermined angle to extract a signal of the radio wave in the first OAM mode; and
combining signals of the radio wave in the first OAM mode and the radio wave in the second OAM mode received by the second antenna with signals obtained by rotating OAM phases of the radio wave in the first OAM mode and the radio wave in the second OAM mode received by the first antenna by the predetermined angle to extract a signal of the radio wave in the second OAM mode.
